(19) United States
(12) Patent Application Publication
(10) Pub. No.: US 2012/0050916 A1
(43) Pub. Date: Mar. 1, 2012

(54) HYDRODYNAMIC DISC DRIVE SPINDLE MOTOR HAVING HYDRO BEARING WITH LUBRICANT

(75) Inventor: Raquib Uddin Khan, Pleasanton, CA (US)

(73) Assignee: SEAGATE TECHNOLOGY LLC, Scotts Valley, CA (US)

(21) Appl. No.: 12/872,109

(22) Filed: Aug. 31, 2010

(51) Int. Cl. G11B 15/64

(52) U.S. Cl. 360/224; G9B/15.083

(57) ABSTRACT

Disc drive spindle motor having hydro bearing including a central axis; a stationary member which is fixed with respect to a housing and coaxial with the central axis; a stator is fixed with respect to the housing; a rotatable member which is rotatable about the central axis with respect to the stationary member; a rotor supported by the rotatable member and magnetically coupled to the stator; a hydro bearing interconnecting the stationary member and the rotatable member and having working surfaces separated by a lubricating fluid. The lubricating fluid contains a synthetic ester base fluid having a viscosity index of at least 110, from 0.01% to 5% by weight, based on the total weight of the lubricating fluid, of at least one tri-C₆-C₁₄-aryl phosphate, and from 0.01% by weight to 5% by weight, based on the total weight of the synthetic ester base fluid, of at least one carbodiimide.

### SUMMARY

Disclosed spindle motors include a stationary member; a rotatable member which is rotatable with respect to the stationary member; a hydro bearing interconnecting the stationary member and the rotatable member and having working surfaces separated by a lubricating fluid, wherein the lubricating fluid includes: a synthetic ester base fluid having a viscosity index of at least 110; from 0.01% to 5% by weight, based on the total weight of the lubricating fluid, of at least one tri-C₆-C₁₄-aryl phosphate wherein each of the aryl groups has from 1 to 3 identical or different substituents selected from C₁-C₁₂-alkyl groups; and from 0.01% to 5% by weight, based on the total weight of the lubricating fluid, of at least one carbodiimide.

Also disclosed is a spindle motor that includes a stationary member; a rotatable member which is rotatable with respect to the stationary member; a hydro bearing interconnecting the stationary member and the rotatable member having working surfaces separated by a lubricating fluid, wherein the lubricating fluid includes a synthetic ester base fluid having a viscosity index of at least 110; from 0.01% to 5% by weight, based on the total weight of the lubricating fluid, of at least one triaryl phosphate; from 0.01% to 5% by weight, based on the total weight of the lubricating fluid, of at least one carbodiimide.

Also disclosed is a lubricating fluid that includes a synthetic ester base fluid having a viscosity index of at least 110; from 0.01% to 5% by weight, based on the total weight of the lubricating fluid, of at least one tri-C₆-C₁₄-aryl phosphate wherein each of the aryl groups has from 1 to 3 identical or different substituents selected from C₁-C₁₂-alkyl groups; and from 0.01% to 5% by weight, based on the total weight of the lubricating fluid, of at least one carbodiimide.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings, in which:

FIG. 1 is a top plan view of a disc drive data storage device comprising a hydrodynamic or hydrostatic bearing spindle motor with a lubricating fluid.

FIG. 2 is a sectional view of a hydrodynamic spindle motor.

FIG. 3 is a diagrammatic sectional view of the hydrodynamic spindle motor taken along line 3-3 of FIG. 2, with portions removed for clarity.

FIGS. 4A and 4B are graphs showing results from Example 2.

FIG. 5 is a graph showing results from Example 3.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

“Include,” “including,” or like terms such as “comprise” or “comprising” means encompassing but not limited to, that is, including and not exclusive.

As used herein the expression “synthetic ester” refers to any ester compound suitable to be employed in a base fluid (also designated in the art as functional fluid or working fluid) of a lubricant.

The expression “synthetic ester base fluid” as used herein collectively refers to any and all synthetic esters employed in formulating a lubricating fluid. The expression, therefore, may designate a single synthetic ester, or a combination of two or more synthetic esters, depending on whether the synthetic ester component of the lubricating fluid consists of a single ester or of a combination of two or more synthetic esters.

The expression “viscosity index” or “VI” as used herein refers to an artificially created index indicating the change of kinematic viscosity of a base fluid with temperature as set up by the Society of Automotive Engineers (SAE). Unless indicated otherwise, the temperatures chosen for reference are 100° Fahrenheit (F) (40° C.) and 210° F. (100° C.).

Unless specifically stated otherwise, the expression “hydrocarbon” designates a moiety consisting of carbon and hydrogen atoms which may be straight chain or branched and may be, or may comprise, one or more cyclic group(s). In general and unless specifically stated otherwise, the hydrocarbon group may be saturated, partially unsaturated or aromatic, and may comprise sub-moieties which are saturated, partially unsatu35 rated or aromatic. In general and unless specifically stated otherwise, a saturated straight-chain hydrocarbon moiety or sub-moiety, also referred to as “alkyl,” can have from 1 to about 20 carbon atoms, whereas a saturated and branched hydrocarbon moiety or sub-moiety, also referred to as “alkyl,” a saturated or partially unsaturated cyclic hydrocarbon moiety or submoiety, also referred to as “cyclically” and “cycloalkenyl,” respectively, and a. partially unsaturated straight-chain or branched hydrocarbon moiety or sub-moiety, also referred to as “alkenyl” or “alkynyl,” can have from about 3 to about 20 carbon atoms. In general and unless specifically stated otherwise, an aromatic hydrocarbon moiety or sub-moiety, also referred to as “aryl,” can have from about 6 to about 18, i.e., 6, 10, 14 or 18, carbon atoms.

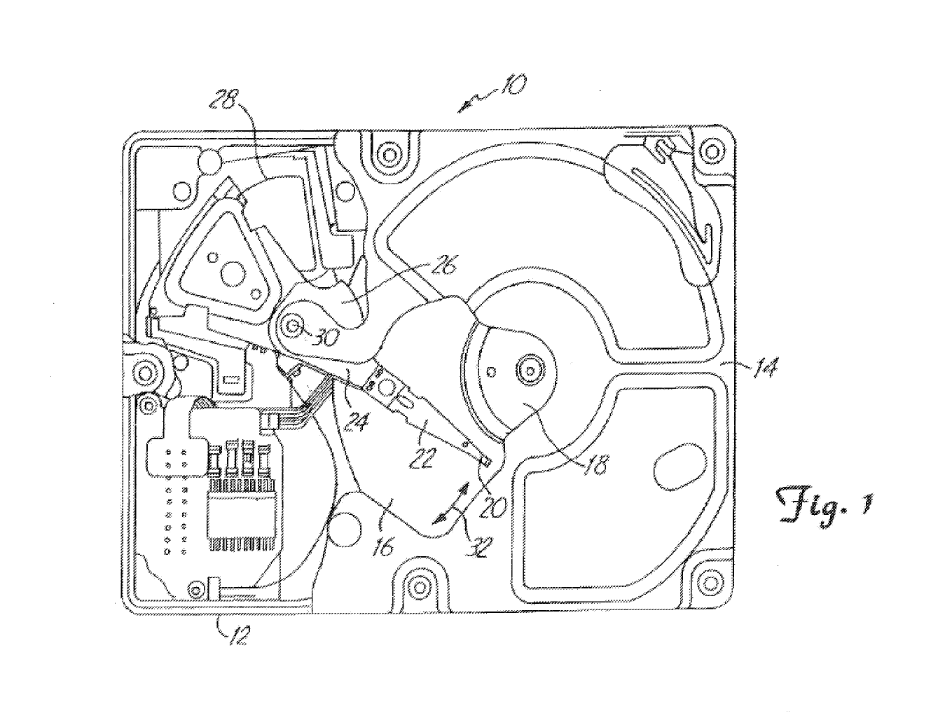

A hydrodynamic or hydrostatic bearing spindle motor including a disclosed lubricating fluid composition can be suited for a disc drive. FIG. 1 is a top plan view of a typical disc drive 10. Disc drive 10 includes a housing base 12 and a top cover 14. The housing base 12 is combined with top cover 14 to form a sealed environment to protect the internal components from contamination by elements from outside the sealed environment.

Disc drive 10 further includes a disc pack 16 which is mounted for rotation on a spindle motor (not shown) by a disc clamp 18. Disc pack 16 includes a plurality of individual discs which are mounted for co-rotation about a central axis. Each disc surface has an associated head 20 which is mounted to disc drive 10 for communicating with the disc surface. In the example shown in FIG. 1, heads 20 are supported by flexures 22 which are in turn attached to head mounting arms 24 of an actuator body 26. The actuator shown in FIG. 1 is of the type known as a rotary moving coil actuator and includes a voice coil motor (VCM), shown generally at 28. Voice coil motor 28 rotates actuator body 26 with its attached heads 20 about a pivot shaft 30 to position heads 20 over a desired data track along an arcuate path 31. While a rotary actuator is shown in FIG. 1, the spindle motor, is also useful in disc drives having other types of actuators, such as linear actuators.

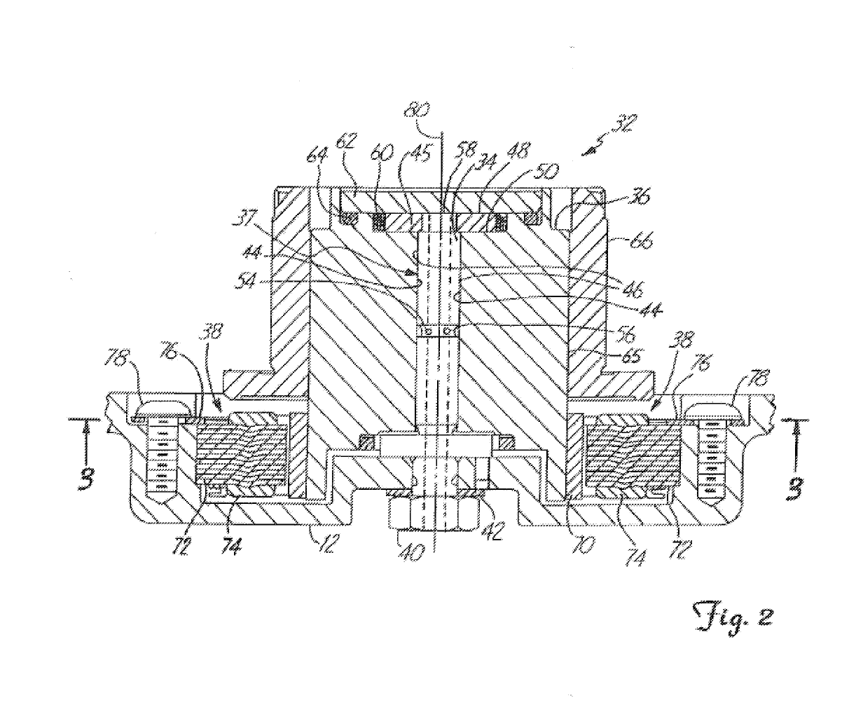

FIG. 2 is a sectional view of a hydrodynamic bearing spindle motor 32. Spindle motor 32 includes a stationary member 34, a hub 36 and a stator 38. In the embodiment shown in FIG. 2, the stationary member is a shaft which is fixed and attached to base 12 through a nut 40 and a washer 42. Hub 36 is interconnected with shaft 34 through a hydrodynamic bearing 37 for rotation about shaft 34. Bearing 37 includes radial working surfaces 44 and 46 and axial working surfaces 48 and 50. Shaft 34 includes fluid ports 54, 56 and 58 which supply lubricating fluid 60 and assist in circulating the fluid along the working surfaces of the bearing. Lubricating fluid 60 is supplied to shaft 34 by a fluid source (not shown) which is coupled to the interior of shaft 34 in a known manner.

Spindle motor 32 further includes a thrust bearing 45 which forms the axial working surfaces 48 and 50 of hydrodynamic bearing 37. A counterplate 62 bears against working surface 48 to provide axial stability for the hydrodynamic bearing and to position hub 36 within spindle motor 32. An 0-ring 64 is provided between counterplate 62 and hub 36 to seal the hydrodynamic bearing. The seal prevents hydrodynamic fluid 60 from escaping between counterplate 62 and hub 36.

Hub 36 includes a central core 65 and a disc carrier member 66 which supports disc pack 16 (shown in FIG. 1) for rotation about shaft 34. Disc pack 16 is held on disc carrier member 66 by disc clamp 18 (also shown in FIG. 1). A permanent magnet 70 is attached to the outer diameter of hub 36, which acts as a rotor for spindle motor 32. Core 65 is formed of a magnetic material and acts as a back-iron for magnet 70. Rotor magnet 70 can be formed as a unitary, annular ring or can be formed of a plurality of individual magnets which are spaced about the periphery of hub 36. Rotor magnet 70 is magnetized-ho form one or more magnetic poles.

Stator 38 is attached to base 12 and includes stator laminations 72 and a stator windings 74.

Stator windings 74 are attached to laminations 72. Stator windings 74 is spaced radially from rotor magnet 70 to allow rotor magnet 70 and hub 36 to rotate about a central axis 80. Stator 38 is attached to base 12 through a known method such as one or more C-clamps 76 which are secured to the base through bolts 78.

Commutation pulses applied to stator windings 74 generate a rotating magnetic field which communicates with rotor magnet 70 and causes hub 36 to rotate about central axis 80 on bearing 37. The commutation pulses are timed, polarization-selected DC current pulses which are directed to sequentially selected stator windings to drive the rotor magnet and control its speed.

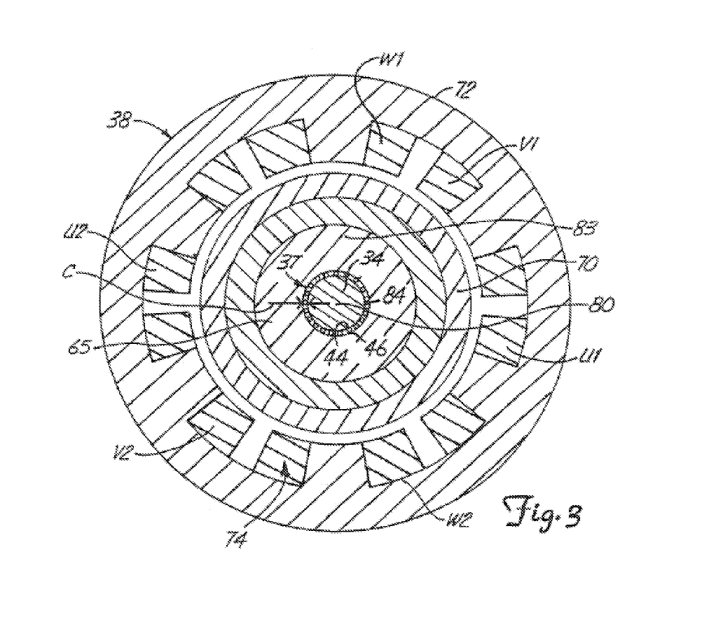

In the embodiment shown in FIG. 2, spindle motor 32 is a “below-hub” type motor in which stator 38 has an axial position that is below hub 36. Stator 38 also has a radial position that is external to hub 36, such that stator windings 74 are secured to an inner diameter surface 82 (FIG. 3) of laminations 72. In an alternative embodiment, the stator is positioned within the hub, as opposed to below the hub. The stator can have a radial position which is either internal to the hub or external to the hub. In addition, the spindle motor can have a fixed shaft, as shown in FIG. 2 or a rotating shaft. In a rotating shaft spindle motor, the bearing is located between the rotating shaft and an outer stationary sleeve which is coaxial with the rotating shaft.

FIG. 3 is a diagrammatic sectional view of hydrodynamic spindle motor 32 taken along line 3-3 of FIG. 2, with portions removed for clarity. Stator 38 includes laminations 72 and stator windings 74, which are coaxial with rotor magnet 70 and central core 65. Stator windings 74 include phase windings W1, V1, U1, W2, V2 and U2 which are wound around teeth in laminations 72. The phase windings are formed of coils which have a coil axis that is normal to and intersects central axis 80. For example, phase winding W1 has a coil axis 83 which is normal to central axis 80. Radial working surfaces 44 and 46 of hydrodynamic bearing 37 are formed by the outer diameter surface of shaft 34 and the inner diameter surface of central core 65. Radial working surfaces 44 and 46 are separated by a lubrication fluid 60, which maintains a clearance c during normal operation.

### Synthetic Ester Base Fluids

Suitable synthetic ester base fluids in the context of the lubricating fluid in principle include all esters suitable as base oils for lubricating purposes. The synthetic ester base fluid may include a single synthetic ester or a combination of two or more synthetic esters of the same or of different type.

In embodiments, suitable synthetic ester base fluids can include esters of monoalcohols and monocarboxylic acids; di- and polyesters, such as those of di- or polyols and identical or different monocarboxylic acids; di- and polyesters of identical or different monoalcohols and identical or different di- or polybasic carboxylic acids; and polyesters of identical or different di- or polyols and identical or different di- or polybasic carboxylic acids.

In embodiments, the base fluid can exhibit a viscosity index of at least 110. In embodiments, synthetic ester base fluids having a high VI can be utilized. For dieters of dicarboxylic acids and polyol esters, for example, the VI typically ranges from about 115 or 120 respectively to 200.

In embodiments where the ester includes one or more moieties derived from monoalcohols, the monoalcohols can be saturated, aliphatic alcohols [e.g., of formula (CₙH₂ₙ₋₁)OH]. In embodiments, such alcohols can have from about 3 to about 20 carbon atoms. The hydrocarbon moiety of the alcohols can be saturated, and may be straight-chain or branched. The alcohol can form or include one or more saturated alicyclic moieties. Exemplary saturated, aliphatic alcohols can include 1-propanol, 1-butanol, 1-pentanol, 1-hexanol, 1-heptanol, 1-octanol(capryl alcohol), 1-nonanol(pelargonic alcohol), 1-decanol(capric alcohol), 1-undecanol, 1-dadecanol(lauryl alcohol), 1-tridecanol, 1-tetradecanol(myristyl alcohol), 1-pentadecanol, 1-hexadecanol(cetyl alcohol), 1-heptadecanol and the like, as well as their branched isomers in which the hydroxyl group is in the 2- or 3-position, and/or in which the hydrocarbon chain carries one or two methyl and/or ethyl branches. Illustrative specific examples of such branched aliphatic alcohols include iso-forms having a terminal CH(CH₃)₂ moiety and neo-forms comprising a C—C(CH₃)₂—C moiety. Also suitable are monoalcohols such as polyoxyalkylene ethers that can be represented by the formula R—O—(Z¹—O—)ₓH in which
R denotes a hydrocarbon which is straight-chain, branched or alicyclic and which may include alicyclic segments or substituents,
x is an integer, e.g., from 1 to 5, and
Z¹ represents identical or different C₂-C₄-alkylene groups such as 1,2-ethylene, 1,2-propylene, 1,3-propylene, 1,2-butylene, 2,3-butylene, 1,3-butylene, 1,4-butylene and the like.

Additionally, the (Z¹—O)ₓ group may represent a five or six-membered ring formed by one or two oxygen and 3, 4 or 5 carbon ring members. In the case of esters which comprise more than one moiety derived from a monoalcohol, the respective alcohol moieties may be identical or different.

Where the ester includes one or more moieties derived from di- and polyols, embodiments can utilize synthetic esters in which the di- or polyols are saturated, aliphatic alcohols [e.g., of formula (CₙH₂ₙ−x)(C(═O)OH)₂₊ₓ with x being 0 in the case of diols and x being ≧1, for example 1, 2 or 3, in the case of polyols] in particular having from about 3 to about 20 carbon atoms. In embodiments, hydroxyl groups of the di- and polyols are not bonded to the same carbon atom. The di- and polyols may be straight-chain or branched and may form or include one or more saturated alicyclic groups. Illustrative examples of saturated, ali-phatic diols include 1,3-propyleneglycol, 1,4-butyleneglycol, 1,5-pentyleneglycol, 1,6-hexyleneglycol, 1,7-heptyleneglycol, 1,8-octyleneglycol, 1,9-nonyleneglycol, 1,10-decyleneglycol, 1,11-undecyleneglycol, 1,12-dodecyleneglycol, 1,13-tridecylene-glycol, 1,14-tetradecyleneglycol, 1,15-pentadecyleneglycol, 1,16-hexadecyleneglycal, 1,17-heptadecyleneglycol and the like, as well as their branched isomers in which one or both of the hydroxyl groups is bonded to a non-terminal carbon atom of the alkylene chain, and/or in which the alkylene chain carries one or two methyl and/or ethyl branches bonded to any position along the alkylene chain. Also suitable are diols such as polyoxyalkylene glycols as represented by formula H—O—(Z¹—O—)ₓH in which x is an integer, e.g., from 1 to 5, and Z¹ represents identical or different C₂-C₄-alkylene groups such as 1,2-ethylene, 1,2-propylene, 1,3-propylene, 1,2-butylene, 2,3-butylene, 1,3-butylene, 1,4-butylene and the like. Additionally, the (Z¹—O)ₓ group may represent a five or six-membered ring formed by one or two oxygens and 3, 4 or 5 carbon ring members. Illustrative examples of saturated, aliphatic polyols include for example glycerine, trimethylol-propane and pentaerythritol. In the case of esters which include more than one moiety derived from a di- or polyol, the respective moieties may be identical or different.

Where the ester comprises one or more moieties derived from monocarboxylic acids, embodiments can utilize synthetic esters are preferred in which the monocarboxylic acids are saturated, aliphatic acids [e.g., of formula (CₙH_{2+1C})C(═O)OH], in particular acids having from about 3 to about 20 carbon atoms. The hydrocarbon moiety of such acids can be saturated, and may be straight-chain or branched and may form or include one or more saturated alicyclic groups. Representatives of saturated, aliphatic acids include propanoic acid, butanoic acid, pentanoic acid(valeric acid), hexanoic acid(caproic acid), heptanoic acid(enanthic acid), octanoic acid(caprylic acid), nonanoic acid(pelargonic alcohol), decanoic acid(capric acid), 1-undecanoic acid, dodecanoic acid(lauric acid), tridecanoic acid, tetradecanoic acid(myristic acid), pentadecanoic acid, hexadecanoic acid(palmitic acid), heptadecanoic acid, octadecanoic acid(stearic acid) and eicosanoic acid(arachidic acid), as well as their branched isomers in which the carboxyl group is in the 2- or 3-position, and/or in which the hydrocarbon moiety carries one or two. methyl and/or ethyl branches. Illustrative representatives of such branched aliphatic carboxylic acids include iso-forms having a terminal CH(CH₃)₂ moiety and neo-forms including a C—C(CH₃)₂—C moiety. In the case of esters which include more than one moiety derived from a monocarboxylic acid, the respective acid moieties may be identical or different.

Where the ester comprises one or more moieties derived from di- and polycarboxylic acids, embodiments can utilize synthetic esters in which the di- or polycarboxylic acids are saturated, aliphatic acids [e.g., of formula (CₙH₂ₙ₋ₓ)(C(═O)OH)₂₊ₓ with x being 0 in the case of dicarboxylic acids and x being ≧1, for example 1 or 2, in the case of polycarboxylic acids] for example those having from about 3 to about 20 carbon atoms. The di- and polycarboxylic acids may have straight-chain or branched hydrocarbon moieties and may form or include saturated alicyclic moieties. Illustrative examples of saturated, aliphatic dicarboxylic acids include 1,3-propanedioic acid(malonic acid), 1,4-butanedioic acid(succinic acid), 1,5-pentanedioic acid(glutaric acid), 1,6-hexanedioic acid(adipic acid), 1,7-heptanedioic acid(pimelic acid), 1,8-octanedioic acid(suberic acid), 1,9-nonanedioic acid(azelaic acid), 1,10-d canedioic acid(sebacic acid), 1,11-undecanedioic acid, 1,12-dodecanedioic acid, 1,13-tridecanedioic acid, 1,14-tetra-decanedioic acid, 1,15-pentadecanedioic acid, 1,16-hexadecanedioic acid, 1,17-heptadecanedioic acid and the like, as well as their branched isomers in which one or both of the carboxyl groups is bonded to a non-terminal carbon atom of the alkylene chain, and/or in which the alkylene chain carries one or two methyl and/or ethyl branches bonded to any position along the alkylene chain. Illustrative examples of saturated, aliphatic polycarboxylic acids include for example oxalmalonic acid, carballylic acid and the like. In the case of esters which include more than one moiety derived from a di- or polycarboxylic acid, the respective moieties may be identical or different.

In embodiments, the synthetic ester base fluid includes at least one synthetic ester selected from the group of diesters of dicarboxylic acids and full esters of diols.

In embodiments, the synthetic ester base fluid can include one or more esters of formula (I)

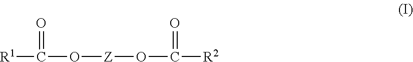

wherein R¹ and R² are identical or different and each represents a straight-chain C₃-C₁₇-alkyl group which optionally carries a C₁-C₃-alkyl branch bonded to a secondary carbon of the chain; and Z is a straight-chain C₃-C₁₀-alkylene group which optionally carries a C₁-C₃-alkyl branch bonded to a carbon of the chain.

In embodiments, the esters of formula (I) can include a total of from about 15 to about 35, from about 15 to about 33, from about 18 to about 30, or from about 18 to about 28, carbon atoms when all carbon atoms present in the longest straight-chain alkyl moiety of R¹ and of R², and all carbon atoms in the straight-chain alkylene moiety of Z are counted without including any carbon atoms of branches. With a view to the moiety Z this means that a moiety which is represented by formula —(CH₂)₂—CH(CH₃)—(CH₂)₂— contributes five carbon atoms, and a moiety which is represented by formula —CH₂—CH(CH₂CH₃)—CH₂— accounts for three carbon atoms. Accordingly, and as example only, a compound (I) in which each of R¹ and R² is an n-heptyl group and Z is a 1,5-pentylene group comprises a total of (7+7+5) 19 carbon atoms in the straight-chain moieties, and a compound (I) in which each of R¹ and R² is a 2-octanyl group (i.e., H₃C—(CH₂)₅—CH(CH₃)—) and Z is a 3-methyl-1,5-pentylene group (i.e., —(CH₂)₂—CH(CH₃)—(CH₂)₂—) also comprises a total of (7+7+5) 19 carbon atoms in the straight-chain moieties.

In embodiments, each of R¹ and R² includes a straight-chain hydrocarbon moiety having from about 6 to about 14 carbon atoms, which straight-chain hydrocarbon moiety optionally carries a methyl, ethyl, propyl or isopropyl branch, the branch being located such that the longest straight-chain hydrocarbon of the group R¹ or R² does not exceed about 14 carbon atoms.

In a further particular embodiment, each of R¹ and R² includes a straight-chain hydrocarbon moiety having from about 6 to about 14 carbon atoms, which straight-chain hydrocarbon moiety optionally carries a methyl or ethyl branch, the branch being located such that the longest straight-chain hydrocarbon of R¹ or of R does not exceed about 14 carbon atoms.

In embodiments, the sum of all branches which are present in R¹, R² and Z is 0, 1 or 2. According to this embodiment, if Z represents a moiety having two branches, each of R¹ and R² represents a straight-chain hydrocarbon group. Correspondingly, if Z represents a moiety having 1 branch, one of the hydrocarbons of R— and R² may carry one branch, or each of R¹ and R² represents a straight-chain hydrocarbon group. Similarly, if Z represents a moiety having no branch, one of the hydrocarbons of R¹ and R² may carry two branches, or one or both of the hydrocarbons of R¹ and R² may carry one branch, or each of R¹ and R² represents a straight-chain hydrocarbon group. In embodiments, the moiety Z carries 0 or 1 branch. In embodiments, each of R¹ and R² consists of a straight-chain hydrocarbon moiety having from about 6 to about 14 carbon atoms. In embodiments, R¹ and R² of the esters of formula (I) can be identical. In embodiments, the synthetic ester base fluid includes at least one ester of formula (I) in which R¹ and R² are independently from one another n-C₆-C₁₂-alkyl and Z is neopentylene (—CH₂—C(CH₃)₂—CH₂—), 1,5-pentylene (—(CH₂)₅—) or 3-methyl-1,5-pentylene (—(CH₂)₂—CH(CH₃)—(CH₂)₂—). In embodiments, the synthetic ester base fluid includes at least two different synthetic esters. In embodiments, the synthetic ester base fluid includes at least two different synthetic esters and at least one of the synthetic esters is of formula (I). In embodiments, the synthetic ester base fluid includes a synthetic ester selected from the group of 3-methyl-1, 5-pentanediol di(n-hexanoate), 3-methyl-1,5-pentane-diol di(n-heptanoate), 3-methyl-1,5-pentanediol di(n-octanoate), 3-methyl-1,5-pentanediol di(n-nonanoate), and 3-methyl-1,5-pentanediol di(n-deaconate), 3-methyl-1,5-pentanediol di(n-undecanoate), 3-methyl-1,5-pentanediol di(n-dodecanoic), and 3-methyl-1,5-pentanediol di(n-tridecanoate), and combinations thereof.

In embodiments, the synthetic ester base fluid includes at least one synthetic ester selected from the group of a mixture of diesters prepared from 3-methyl-1,5-pentanedial and n-hexanoic acid arid n-heptanoic acid; a mixture of diesters prepared from 3-methyl-1,5-pentanediol and n-hexanoic acid and n-octanoic acid; a mixture of diesters prepared from 3-methyl-1,5-pentanediol and n-hexanoic acid and n-nonanoic acid; a mixture of diesters prepared from 3-methyl-1,5-pentanediol and n-hexanoic acid and n-decanoic acid; a mixture of diesters prepared from 3-methyl-1,5-pentanediol and n-heptanoic acid and n-octanoic acid; a mixture of diesters prepared from 3-methyl-1,5-pentanediol and n-heptanoic acid and n-nonanoic acid; a mixture of diesters prepared from 3-methyl-1,5-pentanediol and n-heptanoic acid and n-decanoic acid; a mixture of diesters prepared from 3-methyl-1,5-pentanediol and n-octanoic acid and n-nonanoic acid; and a mixture of diesters prepared from 3-methyl-1,5-pentanediol and n-octanoic acid and n-decanoic acid, or combinations of two or more of these synthetic ester mixtures.

In embodiments, the synthetic ester base fluid can include one or more esters of formula (Ia)

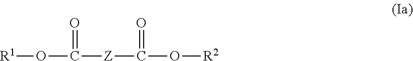

wherein R¹ and R² are identical or different and each represents a straight-chain C₃-C₁₇-alkyl group which optionally carries a C₁-C₃-alkyl branch bonded to a secondary carbon of the chain; and Z is a straight-chain C₃-C₁₀-alkylene group which optionally carries a C₁-C₃-alkyl branch bonded to a carbon of the chain. Compounds of formula Ia can more specifically have the same characteristics of compounds of formula I noted above.

In embodiments, the synthetic ester base fluid includes at least one synthetic ester selected from the group of esters of formula (I) or (Ia); esters of straight-chain C₅-C₁₂₋dicarboxylic acids as mentioned above with (straight-chain or branched chain) C₆-C₁₃-alcohols, such as dioctyl sebacate (for example, 2-ethylhexyl sebacate), dioctyl adipate, dioctyl azelate, and the like; esters of straight-chain C₅-C₁₂ monocarboxylic acids as mentioned above with C₆-C₁₃ dialcohols (either straight or branched chain) (for example 3-methyl 1,5-pentanediol dihexanoate or 3-methyl 1,5-pentane diol dinonanoate); esters of trimethylolpropane; and esters of neopentylglycol.

Neutral Phosphate Esters

A disclosed lubricating fluid also includes at least one neutral phosphate ester. The lubricating fluid may include a single neutral phosphate ester or a combination of two or more neutral phosphate esters. Suitable neutral phosphate esters can include all phosphate triesters (also known as phosphoric acid triesters) (O═)P(OR)₃ wherein the substituents “R” represent identical or different hydrocarbon radicals. The hydrocarbon radicals generally have from about 1 to about 30, in embodiments from about 4 to about 18, carbon atoms and may be, or include, straight-chain or branched alkyl, cycloalkyl and aryl moieties. Moreover, the hydrocarbon radicals may carry one or more halogen substituents. Where present, the halogen substituents can be fluorine, chlorine and/or bromine substituents.

In general, each of the substituent R can independently represent: straight chain or branched C₁-C₁₈-alkyl which is optionally substituted by one or more halogen, C₃-C₁₀-cycloalkyl and/or C₆-C₁₄-aryl groups, and wherein the cyclic groups, in turn, may carry from 1 to 3 substituents selected from the group of halogen, C₁-C₁₀-alkyl, C₃-C₁₀-cycloalkyl and C₆-C₁₄-aryl; C₃-C₁₀-cycloalkyl which may be mono- or polyclyclic and which can be optionally substituted by one or more halogen, C₁-C₁₀-alkyl, C₃-C₁₀-cycloalkyl and/or C₆-C₁₄-aryl groups, wherein each alkyl group in turn may be substituted by one or more halogen, C₃-C₁₀-cycloalkyl and/or C₆-C₁₄-aryl groups, and each of the cyclic groups, in turn, may carry from 1 to 3 substituents selected from the group of halogen, C₁-C₁₀-alkyl, C₃-C₁₀-cycloalkyl and C₆-C₁₄-aryl; C₆-C₁₄-aryl which may be mono- or polycyclic such as phenyl, naphthyl and anthracenyl, which can be optionally substituted by one or more halogen, C₁-C₁₀-alkyl, C₃-C₁₀-(bi)cycloalkyl and/or C₆-C₁₄-aryl groups, wherein each alkyl group in turn may be substituted by one or more halogen, C₃-C₁₀-cycloalkyl and/or C₆-C₁₄-aryl groups, and each of the cyclic groups, in turn, may carry from 1 to 3 substituents selected from the group of halogen, C₁-C₁₀-alkyl, C₃-C₁₀-cycloalkyl and C₆-C₁₄-aryl.

Examples of phosphoric acid triesters accordingly include tributyl (including linear and branched) phosphate, tripentyl (including linear and branched) phosphate, trihexyl (including linear and branched) phosphate, triheptyl (including linear and branched) phosphate, trioctyl (including linear and branched) phosphate, trinonyl (including linear and branched) phosphate, tridecyl (including linear and branched) phosphate, triundecyl (including linear and branched) phosphate, tridodecyl (including linear and branched) phosphate, tritridecyl (including linear and branched) phosphate, tritetradecyl (including linear and branched) phosphate, tripentadecyl (including linear arid branched) phosphate, trihexadecyl (including linear and branched) phosphate, triheptadecyl (including linear and branched) phosphate, trioctadecyl (including linear and branched) phosphates and like tri(linear or branched C₄-C₁₈-alkyl) phosphates having identical or different alkyl groups; tricyclopropyl phosphate, tricyclobutyl phosphate, tricyclopentyl phosphate, tricyclohexyl phosphate, tricycloheptyl phosphate, tricyclooctyl phosphate and like tri(C₃-C₈-cycloalkyl) phosphates, as well as corresponding phosphates in which one or two of the groups R represent(s) C₄-C₁₈-alkyl and the other group(s) R represent(s) C₃-C₈-cycloalkyl; triphenyl phosphate, tricresyl phosphate, trixylenyl phosphate, cresyldiphenyl phosphate, xylenyldiphenyl phosphate, tris(tribromophenyl)phosphate, tris(dibromophenyl)phosphate, tris(2,4-di-t-butylphenyl)phosphate, tri(nonylphenyl)phosphate and like triaryl phosphates, as well as corresponding phosphates in which one or two of the groups R represent(s) C₄-C₁₈-alkyl and the other group(s) R represent(s) aryl, and also corresponding phosphates in which a first group R represents C₄-C₁₈-alkyl, a second group R represents C₃-C₈-cycloalkyl and the third group R represents aryl.

In embodiments, the neutral phosphate ester can be a triaryl phosphate. In embodiments, the neutral phosphate ester can be a tri-C₆-C₁₄-aryl phosphate wherein each of the aryl groups optionally carries from 1 to 3 identical or different substituents selected from halogen and C₁-C₁₂-alkyl groups. In embodiments, the neutral phosphate ester can be a tri-C₆-C₁₄-aryl phosphate wherein each of the aryl groups optionally carries from 1 to 3 identical or different C₁-C₁₂-alkyl groups. In embodiments, the neutral phosphate ester can be a tri-C₆-C₁₀-aryl phosphate wherein each of the aryl groups optionally carries from 1 to 3 identical or different C₁-C₈-alkyl groups. In embodiments, the neutral phosphate ester can be a tri-C₆-C_{10,}-aryl phosphate wherein each of the aryl groups carries at least one C₁-C₈-alkyl groups. In embodiments, the neutral phosphate ester can be a tri aryl phosphate where each of the aryl groups on the tri-C₆-C₁₄-aryl phosphate has from 1 to 3 identical or different substituents selected from C₃-C₆-alkyl groups. In embodiments, the neutral phosphate ester can be a triphenyl phosphate wherein each of the phenyl rings optionally carries from 1 to 3 identical or different substituents selected from halogen and C₁-C₁₂-alkyl groups. In embodiments, the neutral phosphate ester can be a triphenyl phosphate wherein each of the phenyl rings optionally carries from 1 to 3 identical or different C₁-C₁₂-alkyl groups. In embodiments, the neutral phosphate ester can be a triphenyl phosphate wherein each of the phenyl rings optionally carries from 1 to 3 identical or different C₁-C₈-alkyl groups. In embodiments, the neutral phosphate ester can be a triphenyl phosphate wherein each of the phenyl rings carries at least one C₁-C₈-alkyl groups. In embodiments, the neutral phosphate ester can be a triphenyl phosphate wherein each of the phenyl rings carries at least one C₃-C₆-alkyl groups. In embodiments, the neutral phosphate ester can be a triphenyl phosphate wherein each of the phenyl rings carries at least one straight chain or branched butyl group.

In embodiments, the neutral phosphate ester can include aryl phosphate triesters, alkyl phosphate triesters, or combinations thereof. In embodiments, the neutral phosphate ester can include a tri(butylated phenyl)phosphate (such as tri(tertiary butyl phenyl)phosphate), a triphenyl phosphate, resorcinol mono (diphenyl phosphate), resorcinol bis(diphenyl phosphate), or combinations thereof. An exemplary commercially available example of such a phosphate ester is the Syn-O-Ad® line (including all of the Syn-O-Ad® series of additives) of phosphate esters from ICL Industrial Products (St. Louis, Mo.).

The total amount of neutral phosphate ester(s) present in a lubricating fluid can vary broadly. In general, the neutral phosphate ester(s) is(are) employed in a total amount which is effective to improve the anti-wear properties, including high pressure metal contact properties and friction properties, of the lubricating fluid. Effective amounts may range from about 0.01 to about 5.0%; or from about 0.1 to about 4% by weight, based on the total weight of the lubricating fluid. The neutral phosphate ester(s) may be added in larger amounts. However, larger amounts generally do not further improve the suitability of the lubricating fluid for spindle motors and may therefore be uneconomical. It is also possible to employ the neutral phosphate ester(s) in smaller amounts so long as the amounts of the neutral phosphate ester(s) alone or optionally in combination with one or more other anti-wear additives are sufficient to convey anti-wear properties to the lubricating fluid.

Other anti-wear additives suitable for use in the lubricating fluid include, for example, dialkyl dithiophosphates, alkyl and aryl disuiphides and polysulphides, dithiocarbamates, salts of alkylphosphoric acid, molybdenum complex, neutral phosphate ester, and combinations of two or more of these additives. In embodiments, additional anti-wear additives can include, zinc dialkyl dithiophosphate, molybdenum disulphide, liquid amine phosphates, e.g., amine salts of an acid phosphate such as dibutyl phosphate, dioctyl phosphate or dicresyl phosphate (which can be commercially obtained from Ciba Geigy), and amine salts of an acid phosphite such as dibutyl phosphite or diisopropyl phosphite; sulfur-based compounds, e.g., sulfurized oils and fats, sulfurized oldie acid and like sulfurized fatty acids, di-benzyl disulfide, sulfurized olefins or dialkyl disulfides; organometallic compounds such as Zn-dialkyldithio phosphates, Zn-dialkyldithio phosphates, Mo-dialkyldithio phosphates, Mo-dialkyldithio carbonates, etc.

Carbodiimides

Disclosed lubricating fluids may include a single carbodiimide or a combination of two or more carbodiimides. Suitable carbodiimides can include all compounds which include at least one carbodiimide moiety, —N═C═N—, in the molecule.

In embodiments, the carbodiimide is of formula (II)

X—N═C═N—Y (II)

in which

X and Y are identical or different and each represents a C₁-C₂₀-hydrocarbon residue which may be, or include aliphatic, cycloaliphatic and aromatic groups.

In general, each of the substituents X and Y can independently represent: straight chain or branched C₁-C₁₈-alkyl which can be optionally substituted by one or more halogen, C₁-C₁₀-alkoxy, C₃-C₁₀-cycloalkyl and/or C₆-C₁₄-aryl groups, and wherein the cyclic groups, in turn, may carry from 1 to 3 substituents selected from the group of halogen, C₁-C₁₀-alkyl, C₁-C₁₀-alkoxy, C₃-C₁₀-cycloalkyl and c₆-C₁₄-aryl; C₃C₁₀-cycloalkyl which may be mono- or polyclyclic and which can be optionally substituted by one or more halogen, C₁-C₁₀-alkyl, C₁-C₁₀-alkyloxy, C₃-C₁₀-cycloalkyl and/or C₆-C₁₄-aryl groups, wherein each alkyl group in turn may be substituted by one or more halogen, C₁-C₁₀-alkyloxy, C₃-C₁₀-cycloalkyl and/or C₆-C₁₄-aryl groups, and each of the cyclic groups, in turn, may carry from 1 to 3 substituents selected from the group of halogen, C₁-C₁₀-alkyl, C₁-C₁₀-alkyloxy, C₃-C₁₀-cycloalkyl and C₆-C₁₄-aryl; C₆-C₁₄-aryl which may be mono- or polycyclic such as phenyl, naphthyl and anthracenyl, which is optionally substituted by one or more halogen, C₁-C₁₀-alkyl, C₃-C₁₀-(bi)cycloalkyl and/or C₆-C₁₄-aryl groups, wherein each alkyl group in turn may be substituted by one or more halogen, C₁-C₁₀-alkyloxy, C₃-C₁₀-cycloalkyl and/or C₆-C₁₄-aryl groups, and each of the cyclic groups, in turn, may carry from 1 to 3 substituents selected from the group of halogen, C₁-C₁₀-alkyl, C₁-C₁₀-alkyloxy, C₃-C₁₀-cycloalkyl and C₆-C₁₄-aryl.

In embodiments, X and Y can be identical or different and can each represent a C₁-C₁₂-alkyl, C₃-C₈-cycloalkyl, C₆-C₁₄-aryl, or C₆-C₁₄-aryl-C₁-C₄-alkyl group wherein the cyclic moieties optionally carry one, two or three identical or different substituents.

X and Y may be, or include, for example alkyl groups such as methyl, ethyl, propyl, isopropyl, butyl, isobutyl, pentyl, 2-methylbutyl, hexyl, heptyl, octyl, 2-ethylhexyl, nonyl, decyl, undecyl dodecyl and the like, alkenyl groups such as propenyl, butenyl, isobutenyl, pentenyl 2-ethylhexenyl, octenyl and the like, cycloalkyl groups such as cyclopentyl, cyclohexyl, methylcyclopentyl, ethylcyclopentyl and the like, aryl groups such as phenyl, naphthyl, anthracenyl and the like, alkyl substituted aryl groups such as alkyl substituted phenyl groups for example toluyl, isopropylphenyl, diisopropylphenyl, triisopropylphenyl, nonylphennyl and the like, aralkyl groups such as benzyl, phenethyl and the like.

Examples of monocarbodiimides are di-isopropyl-carbodiimide, di-n-butyl-carbodiimide, methyl-tert-butyl-carbodiimide, dicyclohexyl-carbodiimide, diphenyl-carbodiimide, di-p-tolyl-carbodiimide, 4,4′-didodecyl-diphenyl-carbodiimide, 2,2′-diethyl-di-phenyl-carbodiimide, 2,2′-di-isopropyl-diphenyl-carbodiimide, 2,2′-diethoxy-diphenyl-carbodiimide, 2,6,2′6′-tetra-ethyl-diphenyl-carbodiimide, 2,6,2′,6′-tetraisopropyl-di-phenyl-carbodiimide, 2,6,2′,6′-tetraethyl-3,3′-dichloro-di-phenyl-carbodiimide, 2,2′-diethyl-6,6′-dichloro-diphenyl-carbodiimide, 2,6,2′,6′-tetra-isobutyl-3,3′-dinitro-diphenyl-carbodiimide and 2,4,6,2′4′,6′-hexaisopropyl-diphenyl-carbodiimide.

Suitable carbodiimides can also include, for example, polycarbodiimides such as tetramethylene-w,w′-bis-(tert-butyl-carbodiimide), hexamethylene-w,w′-bis-(tert-butyl-carbodiimide), tetramethylene-w,w′-bis-(phenyl-carbodiimide) and those compounds which may be obtained by heating aromatic polyisocyanates such as 1,3-di-isopropyl-phenylene-2,4-di-iso-cyanate, 1-methyl-3,5-die-thyl-phenylene-2,4-diisocyanate and 3,5,3′,5′-tetra-isopropyldiphenylxnethane-4,4-di-isocyanate, in the presence of tertiary amines, basically reacting metal compounds, carboxylic acid metal salts or non-basic organometal compounds at a temperature of at least 120°, according to the process of U.S. Pat. No. 3,502,722.

In embodiments, X and Y are identical or different and each can be, or include, at least one C₆-C₁4-aryl group. In embodiments, X and Y can be identical or different and each can be, or include, at least one C₆-C₁₄-aryl group wherein the carbodiimide group —N═C═N— is directly bonded to an aryl carbon atom. In embodiments, X and Y can be identical or different and each can be, or include, at least one C₆-C₁₄-aryl group wherein the carbodiimide moiety —N═C═N— is directly bonded to an aryl carbon atom, and the directly bonded aryl group further carries at least one substituent in ortho position relative to the cabodiimide moiety. In embodiments, X and Y can be identical or different and each can be, or include, at least one C₆-C₁₄-aryl group wherein the carbodiimide moiety —N═C═N— is directly bonded to an aryl carbon atom, and the directly bonded aryl group further carries at least two substituents in ortho position relative to the cabodiimide moiety, wherein the ortho substituents are independently of one another branched or cyclic aliphatic groups having at least 3 carbon atoms. In embodiments, X and Y can be identical or different and each can be, or include, at least one C₆-C₁₄-aryl group wherein the carbodiimide moiety —N═C═N— is directly bonded to an aryl carbon atom, and the directly bonded aryl group further carries two or three substituents in ortho or in ortho and para position relative to the cabodiimide moiety. In embodiments, X and Y can be identical or different and each can be, or include, at least one C₆-C₁₄-aryl group wherein the carbodiimide moiety —N═C═N— is directly bonded to an aryl carbon atom, and the directly bonded aryl group further carries two or three substituents in ortho or in ortho and para position relative to the cabodiimide moiety, and at least one of the substituents is a branched C₃-C₆-alkyl or a C₃-C₆-cycloalkyl group.

In embodiments, the carodiimide can include diaryl carbodiimides, substituted diaryl carbodiimides, or combinations thereof. In embodiments, the carbodiimide can include 2,2′,2,2′-tetraisopropyldiphenyl carbodiimide. ADDITIN® RC 8500 and STABAXOL® 1 LF, are commercially available substituted diaryl carbodiimides available from Rhein Chemie Rheinau GmbH (Mannheim, Germany).

The total amount of carbodiimide(s) present in a lubricating fluid can vary broadly. In general, the carbodiimide(s) is (are) employed in a total amount which is effective to prevent, suppress or sufficiently inhibit hydrolytic deterioration of the constituents of the lubricating fluid. Effective amounts may range from 0.01 to 5.0%, from 0.05 to 5%, or from 0.1 to 3% based on the total weight of the lubricating fluid. The carbodiimide(s) may be added in larger amounts. However, large-amounts generally do not further improve the suitability of tile lubricating fluid for spindle motors and may therefore be uneconomical. The carbodiimide(s) may also be added in smaller amounts so long as the amounts are effective to prevent, suppress or sufficiently inhibit hydrolytic deterioration of the constituents of the lubricating fluid.

Further Additives

The lubricating fluid may optionally include effective amounts of one or more additives such as antioxidants, corrosion inhibitors, viscosity index modifiers, pour point depressants, anti-foaming agents, metal detergents and electrically conductive, non-metallic additives.

Suitable antioxidants can include all compounds which can suppress, prevent or diminish the oxidation of the lubricating fluid and/or the working surfaces of the spindle motor, such as amine-based antioxidants, phenol-based antioxidants, di(n-dodecyl)thiodipropionate, di(n-octadecyl)thiodipropionate and the like thiodipropionates, phenothiazine and the like sulfur-based compounds, etc.

In embodiments, the lubricating fluid can include at least one amine-based antioxidant or a combination of two or more amine-based antioxidants. Any amine-based antioxidants can be utilized. In embodiments, the amine-based antioxidant can be a compound which contains no sulfur in the molecule, and has from about 6 to 60, or from about 10 to 40, carbon atoms. In embodiments, the amine-based antioxidant can be selected from the group consisting of diaryl amines wherein the aryl groups are identical or different and each can be C₆-C₁₄-aryl which optionally carries one, two or three identical or different substituents selected from the group consisting of halogen and C₁-C₁₂-alkyl groups. In embodiments, the amine-based antioxidant can be selected from the group consisting of diaryl amines wherein the aryl groups are identical or different and each can be C₆-C₁₄-aryl which optionally carries one, two or three identical or different C₃-C₁₂-alkyl substituents.

Illustrative examples can include diphenylamines such as diphenylamine, monobutyl (including linear and branched) diphenylamines, monopentyl (including linear and branched) diphenylamines, monohexyl (including linear and branched) diphenylamines, monobutyl (including linear and branched) diphenylamines, monopentyl (including linear and branched) diphenylamines and like monoalkyl diphenylamines, in particular, mono(C₄-C₉-alkyl)diphenylamines (i.e., diphenylamines wherein one of the two benzene rings is mono-substituted with an alkyl group, in particular, a C₄-C₉-alkyl group, i.e., a monoalkyl-substituted diphenylamines); p,p′-dibutyl (including linear and branched) diphenylamines, p,p′-dipentyl (including linear and branched) diphenylamines, p,p′-dihexyl (including linear and branched) diphenylamines, p,p′-diheptyl (including linear and branched) diphenylamines, p,p′-dioctyl (including linear and branched) diphenylamines, p,p′-dinonyl (including linear and branched) diphenylamines and like di(alkylphenyl)amines, in particular, p,p′-di(C₄-C₉-alkylphenyl)amines (i.e., dialkyl substituted diphenylamines wherein each of the benzene rings is mono-substituted with an alkyl group, in particular, a C₄-C₉-alkyl group, and the two alkyl groups are identical); di(mono C₄-C₉-alkylphenyl)amines wherein the alkyl group on one of the benzene rings is different from the alkyl group on the other of the benzene rings; di(di-C₄-C₉-alkylphenyl)amines wherein at least one of the four alkyl groups of the two benzene rings is different from the rest of the alkyl groups; naphthylamines such as N-phenyl-1-naph-thylamine, N-phenyl-2-naphthylamine, 4-octylphenyl-1-naphthylamine, 4-octylphenyl-2-naphthylamine and the like; phenylene-diamines such as p-phenylenediamine, N-phenyl-N′-isopropyl-p-phenylenediamine, N-phenyl-N′-(1,3-dimethylbutyl)-p-phenylenediamine and the like. In embodiments, p,p′-dioctyl (including linear and branched) diphenylamine, p,p′-dinonyl (including linear and branched) diphenylamine, and N-phenyl-1-naphthylamine can be utilized.

In embodiments, the lubricating fluid can include at least two different types of antioxidants. In embodiments, the lubricating fluid can include at least one amine-based antioxidant and at least one further antioxidant which is of a different type. In embodiments, the lubricating fluid can include at least one amine-based antioxidant and at least one phenol-based antioxidant. In embodiments a single phenol based antioxidant or two or more can be utilized. In embodiments, any phenol-based antioxidant can be utilized. In embodiments, a phenol-based antioxidant can be a compound which contains no sulfur atoms in the molecule. In embodiments, phenol-based antioxidants can have from about 6 to 100 carbon atoms, or from about 10 to 80 carbon atoms.

In embodiments, the phenol-based antioxidant can be selected from 2,6-di-t-butylphenol, 2,6-di-t-butyl-p-cresol, 4,4′-methylenebis (2,6-di-t-butylphenol), 4,4′-butylidene bis (3-methyl-6-t-butylphenol), 2,2′-methylenebis (4-ethyl-6-t-bu-tylphenol), 2,2′-methylenebis (4-methyl-6-t-butylphenol), 4,4′-isopropylidenebisphenol, 2,4-dimethyl-6-t-butylphenol, tetrakis[methylene-3-(3,5-di-t-butyl-4-hydroxyphenyl)-propionate]methane, 1,1,3-tris(2-methyl-4-hydroxy-5-t-butylphenyl)butane, 1,3,5-trimethyl-2,4,6-tris (3,5-di-t-butyl-4-hydroxybenzyl)-benzene2,2′-dihydroxy-3,3′-di(α-methylcyclohexyl)-5,5′-dimethyl-diphenylmethane, 2,2′-isobutylidenebis (4,6-dimethylpheriol), 2,6-bis (2′-hydroxy-3′-t-butyl-5′-methylbenzyl)-4-methyiphenol, 1,1′-bis(4-hydroxyphenyl)cyclohexane, 2,5-di-t-amylhydroquinone, 2,5-di-t-butylhdroquinone, 1,4-dihydroxyanthraquinone, 3-t-butyl-4-hydroxyanisole, 2-t-butyl-4-hydroxyanisole, 2,4-dibenzoyl-resorcinol, 4-t-butylcatechol, 2,6-.di-t-butyl-4-ethylphenol, 2-hydroxy-4-methoxybenzophenone, 2,4-dihydroxybenzophenone, 2,2′-dihydroxy-4-methoxybenzophenone, 2,4,5-trihydroxybenzophe-none, α-tocopberol, bis[2-(2-hydroxy-5-methyl-3-t-butylbenzyl)-4-methyl-6-t-butylphenyl]terephthalate, triethylene glycol bis[3-t-butyl-5-methyl-4-hydroxyphenyl)propionate, 1,6-hexane-diol-bis[3-(3,5-.di-t-butyl-4-hydroxyphenyl)propionate], for example.

In embodiments, the phenol-based antioxidant can be selected from 2,6-di-t-butyl-p-cresol, 4,4′-methylene bis(2,6-di-t-butylphenol), 2,6-di-t-butyl-4-ethylphenol, or combinations thereof.

In embodiments where the lubricating fluid includes a combination of one or more phenol-based antioxidants and one or more amine-based antioxidants, the ratio of phenol-based antioxidant(s) to amine-based antioxidant(s) can be suitably selected from a wide range, and the weight ratio of the phenol-based antioxidant (PBA) to the amine-based antioxidant (ABA) can be at least about 1 (PBA) to 0.05 (ABA) and up to 1 (PBA) to 20 (ABA). In embodiments, the ratio may be from at least about 1 (PBA) to 0.2 (ABA) and up to 1 (PBA) to 5 (ABA).

Illustrative embodiments of antioxidant combinations including at least one amine-based antioxidant and at least one phenol based antioxidant include: one or more members selected from the group consisting of 2,6-di-t-butyl-p-cresol, 4,4′-methylenebis (2,6-di-t-butyl-phenol), and 2,6-di-t-butyl-4-ethylphenol, one or more members selected from the group consisting of p,p′-dioctyl (including linear and branched) diphenylamine, p,p′-dinonyl (including linear and branched) diphenylamine and N-phenyl-1-naphthylamine; and combinations thereof.

In embodiments, the lubricating fluid can include one or more of the following combinations: 2,6-di-t-butyl-p-cresol and p,p′-dioctyl (including linear and branched) diphenylamine; 2,6-di-t-butyl-p-cresol and p,p′-dinonyl (including linear and branched) diphenylamine; 2,6-di-t-butyl-p-cresol and N-phenyl-1-naphthylamine, -4,4′-methylenebis(2,6-di-t-butylphenol) and p,p′-dioctyl (including linear and branched) diphenylamine; 4,4′-methylenebis (2,6-di-t-butylphenol) and p,p′-dinonyl (including linear and branched) diphenylamine; 4,4′-methylenebis (2,6-di-t-butylphenol) and N-phenyl-1-naphthylamine; 2,6-di-t-butyl-4-ethylphenol and p,p′-dioctyl (including linear and branched) diphenylamine; 2,6-di-t-butyl-4-ethylphenol and p,p′-dinonyl (including linear and branched) diphenylamine; and 2,6-di-t-hutyl-4-ethylphenol and N-phenyl-1-naphthylamine.

In embodiments, the lubricating fluid can include one or more of the following combinations: 4,4′-methylenebis (2,6-di-t-butylphenol) and p,p′-dioctyl (including linear and -branched) diphenylamine; 4,4′-methylenebis (2,6-di-t-butylphenol) and p,p′-dinonyl (including linear and branched) diphenylamine, and 4,4′-methylenebis (2,6-di-t-butylphenol) and N-phenyl-1-naphthylamine.

The total amount of antioxidant(s) present in a lubricating fluid can vary broadly. In general, the antioxidant(s) is (are) employed in a total amount which can be effective to prevent, suppress or sufficiently inhibit oxidative deterioration of the constituents of the lubricating fluid. Effective amounts may range from 0.01 to 5.0%, from 0.05 to 5%, or from 0.1 to 3% based on the total weight of the lubricating fluid. The antioxidant(s) may be added in larger amounts. However, larger amounts generally do not further improve the suitability of tile lubricating fluid for spindle motors and may therefore be uneconomical. The antioxidant(s) may also be added in smaller amounts so long as the amounts are effective to prevent, suppress or sufficiently inhibit an oxidative deterioration of the constituents of the lubricating fluid.

Lubricating fluids may also optionally include corrosion inhibitors. Suitable corrosion inhibitors (metal detergents, metal passivators, rust inhibitors) can include compounds which suppress, prevent or diminish corrosion of the working surfaces of the spindle motor, such as sulfonates, hydrocarbyl amines, carboxylic acid derivatives, imidazolines, thia(dia)zoles, (benzo)triazoles and amine phosphates.

In embodiments, the lubricating fluid can include at least one natural or synthetic sulfate that includes a hydrocarbon group having at least 9 carbon atoms, or a salt thereof. In embodiments, the lubricating fluid can include at least one salt of a natural or synthetic sulfate including a hydrocarbon group having at least 9 carbon atoms.

In embodiments, the lubricating fluid can include at least one Ca-petroleum sulfonate, over based Ca-petroleum sulfonate, Ca-alkylbenzene sulfonate, over based Ca-alkylbenzene sulfonate, Ba-alkylbenzene sulfonate, over based Ba-alkylbenzene sulfonate, Mg-alkylbenzene sulfonate, over based Mg-alkylbenzene sulfonate, Na-alkylbenzene sulfonate, over based Na-alkylbenzene sulfonate, Ca-alkylnaphthalene sulfonate, over based Ca-alkylnaphthalene sulfonate or like metal sulfonates; Ca-phenate, over based Ca-phenate, Ba-phenate, over based Ba-phenate or like metal phenates; Ca-salicylate, over based Ca-salicylate or like metal salicylates; Ca-phosphonate, over based Ca-phosphonate, Ba-phosphonate, over based Ba-phosphonate or like metal phosphonates; over based Ca-carboxylate, etc. In embodiments, the lubricating fluid can include at least one Ca-petroleum sulfonate, Ca-alkylbenzene sulfonate, Ba-alkylbenzene sulfonate, Mg-alkylbenzene sulfonate, Na-alkylbenzene sulfonate, Zn-alkylbenzene sulfonate, Ca-alkylnaphthalene sulfonate or like metal sulfonate.

In embodiments, the lubricating fluid can include at least one hydrocarbon substituted amine such as ethylamine, diethylamine, triethylamine, a primary, secondary or tertiary amine having one, two or three alkyl substituents each independently having from one to twenty carbon atoms, phenylene diamine, cyclohexylamine, morpholine, ethylene diamine, triethylene tetramine, tetraethylene pentamine and the like. In embodiments, the lubricating fluid can include at least one salt of a hydrocarbon substituted amine. In embodiments, the lubricating fluid can include at least one of rosin amine, N-oleyl sarcosine and like amines.

In embodiments, the lubricating fluid can include at least one carboxylic acid or carboxylic acid salt including a hydrocarbon group having at least 7 carbon atoms. In embodiments, the carboxylic acid or the salt thereof can include a hydrocarbon group having from 10 to 22 carbon atoms, or from 14 to 18 carbon atoms. Specific examples include n-dodecanoic acid, n-tridecanoic acid, n-tetradecanoic acid, n-pentadecanoic acid, n-hexadecanoic acid, n-heptadecanoic acid, n-octadecanoic acid, n-nonadecanoic acid, n-icosanoic acid, n-docosanoic acid, oleic acid, etc. In embodiments, n-tetradecanoic acid, n-hexadecanoic acid, and n-octadecanoic acid can be utilized. In embodiments, the lubricating fluid can include at least one dodecenylsuccinic acid half ester, octadecenylsuccinic anhydride, dodecenylsuccinic acid amide or like alkyl or alkenyl succinic acid derivative; sorbitan monooleate, glycerol monooleate, pentaerythritol monooleate or like partial esters of polyhydric alcohols.

In embodiments, the carboxylic acid derivative can be a gallic acid based compound. Examples of gallic acid-based compounds include those having 7 to 30 carbon atoms, or from 8 to 20 carbon atoms. Specific examples include gallic acid, methyl gallate, ethyl 10 gallate, propyl (including linear and branched) gallate, butyl (including linear and branched) gallate, pentyl (including linear and branched) gallate, hexyl (including linear and branched) gallate, heptyl (including linear and branched) gallate, octyl (including linear and branched) gallate, nonyl (including linear and branched) gallate, decyl (including linear and branched) gallate, undecyl (including linear and branched) gallate, dodecyl (including linear and branched) gallate, tridecyl (including linear and branched) gallate, tetradecyl (including linear and branched) gallate, pentadecyl (including linear and branched) gallate, hexadecyl (including linear and branched) gallate, heptadecyl (including linear and branched) gallate, octadecyl (including linear and branched) gallate, nonadecyl (including linear and branched) gallate, icosyl (including linear and branched) gallate, docosyl (including linear and branched) gallate and like linear or branched C₁-C₂₂-alkyl esters of gallic acid; and cyclohexyl gallate, cyclopentyl gallate and like C₄-C₈-cycloalkyl esters of gallic acid. In embodiments, (n-propyl)gallate, (n-octyl)gallate, (n-dodecyl)gallate and like linear or branched C₃-C₁₂-alkyl esters of gallic acid can be utilized.

In embodiments, the lubricating fluid can include at least one imidazole, thia(dia)zole- or (benzo)triazole-based compound that functions as a corrosion inhibitor. Essentially, any corrosion inhibiting imidazole, thia(dia)zole- or (benzo)triazole-based compound can be suitable. In embodiments, the corrosion inhibitor can be a triazole-based compound which has no sulfur in the molecule. In embodiments, the triazole-based compound can be a benzotriazole having from 6 to 60 carbon atoms, or from 6 to 40 carbon atoms for example. Illustrative examples include benzotriazole, 5-methyl-1H-benzo-triazole, 1-dioctylaminomethylbenzotriazole, 1-dioctylaminome-thyl-5-methylbenzotriazole, 2-(5′-methyl-2′-hydroxyphenyl) benzo triazole, 2-[2′-hydroxy-3′,5′-bis(α,α-dimethylbenzyl)phenyl]-2H-benzotriazole, 2-(3′,5′-di-t-butyl-2′-hydroxyphenyl) benzotriazole, 2-(3′-t-butyl-5′-methyl-2′-hydroxyphenyl)-5-chlorobenzotriazole, 2-(3,5′-di-t-butyl-2′-hydroxyphenyl)-5-chlorobenzotriazole, 2-(3′,5′-di-t-amyl-2′-hydroxyphenyl)benzotriazole, 2-(5′-t-bu-tyl-2′-hydroxyphenyl)benzotriazole, 2-(2-hydroxy-5′-methylphenyl)benzotriazole, 2-(2′-hydroxy-5′-t-octylphenyl)benzotriazole, 2-[2′-hydroxy-3′-(3″,4″-5″,6″ tetrahydrophthalideme-thyl)-5′-methylphenyl]benzotriazole, etc. In embodiments, the lubricating fluid can include benzotriazole and/or 5-methyl-1H-benzotriazole.

In general, the lubricating fluid may include a single corrosion inhibitor or a combination of two or more corrosion inhibitors of the same or of different type. The total amount of corrosion inhibitor(s) present in the lubricating fluid can vary broadly. In general, the corrosion inhibitor(s) can be employed in an amount(s) which can be effective to prevent, suppress or sufficiently inhibit corrosion of the working surfaces. Effective amounts may range from 0.01 to 5.0%, or from 0.05 to 5%, or from 0.1 to 3% by weight, based on the total weight of the lubricating fluid. The corrosion inhibitor(s) may be added in larger amounts. However, larger amounts generally do not further improve the suitability of the lubricating fluid for spindle motors and may therefore be uneconomical. The corrosion inhibitor(s) may also be added in smaller amounts so long as the amounts are effective to prevent, suppress or sufficiently inhibit the corrosion of the working surfaces of the spindle motor.

Disclosed lubricating fluids can also optionally include one or more viscosity index modifiers. Suitable viscosity index improvers (viscosity modifiers) can include all compounds which provide an increased viscosity at higher temperatures and a minimal viscosity contribution at lower temperatures, for example polymeric compounds. Examples of viscosity index improvers include polyalkylmethacrylates, polyalkylstyrenes, polybutenes, ethylene-propylene copolymers, styrene-diene copolymers, styrene-maleic anhydride ester copolymers, and like olefin copolymers. In general, a lubricating fluid may include a single viscosity index improver or a combination of two or more viscosity index improvers of the same or of different type.

The total amount of viscosity index improver(s) present in the lubricating fluid can vary broadly. In general, viscosity index improver(s) can be employed in amounts which can be effective to provide an increased viscosity at higher temperatures and a minimal viscosity contribution at low temperatures. Effective amounts may range from 0.01 to 5.0%, from 0.05 to 5%, or from 0.1 to 3% by weight, based on the total weight of the lubricating fluid. The viscosity index improver(s) may be added in larger amounts. However, larger amounts generally do not further improve the suitability of the lubricating fluid for spindle motors and may therefore be uneconomical. The viscosity index improver(s) may also be added in smaller amounts so long as the amounts are effective to provide an increased viscosity at higher temperatures and a minimal viscosity contribution at low temperatures.

Disclosed lubricating fluids can also optionally include pour point depressants. Suitable pour point depressants (low temperature flow improvers, wax crystal modifiers) can include all compounds which can improve the cold flow properties of the lubricating fluid, for example polymeric compounds. Examples of suitable pour point depressants include condensates of chlorinated paraffin and alkylnaphthalene, condensates of chlorinated paraffin and phenol, as well as polyalkylmethacrylates, polyalkylstyrenes, polybutenes, etc., which may also act as viscosity index improvers as mentioned above. In general, a lubricating fluid may include a single pour point depressant or a combination of two or more pour point depressants of the same or of different type.

The total amount of pour point depressant(s) present in the lubricating fluid can vary broadly. In general, pour point depressant(s) can be employed in amounts which can be effective to improve cold flow properties of a lubricating fluid. Effective amounts may range from 0.01 to 5.0%, from 0.05 to 5%, or from 0.1 to 3% by weight, based on the total weight of the lubricating fluid. The pour point depressant(s) may be added in larger amounts. However, larger amounts generally do not further improve the suitability of the lubricating fluid for spindle motors and may therefore be uneconomical. The pour point depressant(s) may also be added in smaller amounts so long as the amounts are effective to provide for the requisite cold flow properties.

Disclosed lubricating fluids can also optionally include anti-foaming agents. Suitable anti-foaming agents can include all compounds which can sufficiently suppress, prevent or diminish the tendency of bubble formation of the lubricating fluid. Examples of suitable anti-foaming agents include polysiloxanes, perfluoropolyethers, polyacrylates and similar organic polymers. In general, a lubricating fluid may include a single anti-foaming agent or a combination of two or more anti-foaming agents of the same or of different type.

The total amount of anti-foaming agent(s) present in the lubricating fluid can vary broadly. In general, anti-foaming agent(s) can be employed in amounts which can be effective to sufficiently suppress, prevent or diminish the tendency of bubble formation of the lubricating fluid. Effective amounts may range from 0.01 to 5%, from 0.05 to 5%, or from 0.1 to 3% by weight, based on the total weight of the lubricating fluid. The anti-foaming agent(s) may be added in larger amounts. However, larger amounts generally do not further improve the suitability of the lubricating fluid for spindle motors and may therefore be uneconomical. The anti-foaming agent(s) may also be added in smaller amounts so long as the amounts are effective to sufficiently suppress, prevent or diminish the tendency of bubble formation of the lubricating fluid.

Disclosed lubricating fluids can also optionally include electrically conductive, or non-metallic additives. Suitable conductivity-inducing and/or antistatic agents can include non-metallic compounds which are capable of rendering the lubricating fluid conductive or which are capable of reducing or preventing the build-up of static charges. Non-metallic in this context is intended to exclude all metals and metal particles which, due to their particulate nature, may interfere with the proper functioning of a spindle motor. Compounds which include metal, e.g., in form of ions or in complexed form, however, are understood to be non-metallic.

Conductivity-inducing and/or antistatic agents can include for example compounds and compositions such as: mixtures of chromium dialkyl salicylate and calcium didecyl sulfosuccinate in copolymer of lauryl methacrylate and methyl vinyl pyridine, e.g., ASA-3, manufactured by Shell. The primary dissociating constituent is the chromium dialkyl salicylate, which is stabilized by calcium didecyl sulfosuccinate; solutions in aromatic solvents of a polymeric condensation product of N-tallow-1,3-diaminopropane and epichlorohydrin (3), e.g., Polyfloe 130; solutions of 1-decene polysulfone and dicocodimethylammonium nitrite in toluene; colloidal solutions of alkylsalicylates, sulfonates, succinimides and other polar additives; magnesium oleate, the calcium salt of nitrate lube oil with stearic acid, solution of chromium salts of C₁₇-C₂₀-synthetic fatty acids in toluene, chromium stearate, chromium salt long chain acid, chromium oleate, chromium linoleate, cobalt naphthenate, copper naphthenate, nickel naphthenate, diethylamine, 2-methylpyridine, pyridine, 3-methylpyridine, 2-amino-5-nitropyridine, 2,6-dinitro-3-chloropyridine; stearylanthranylic acid, e.g., Sigbol, ASP-I, Kerostat; conducting polyaniline derivatives made soluble with long chain organic acid or hydrocarbon side chain; or metal ion containing fullerenes, C₆₀₊ₙM where n is 0,1, etc. and M is La, or any metal ion capable of electron transfer.

In embodiments, a conductivity-inducing and/or antistatic agent can include at least one polymeric compound. In embodiments, a conductivity-inducing and/or antistatic agent can include at least one polymeric compound which contains nitrogen. In embodiments, a conductivity-inducing and/or antistatic agent can include at least one polyaniline. In embodiments, a conductivity-inducing and/or antistatic agent can include at least one polyaniline containing polymer unit represented by formula (III)

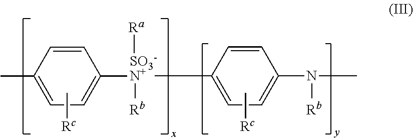

wherein 0<x/y<1, and R^{a}, R^{b} and R^{c} are independently of one another hydrogen or hydrocarbon groups. Additionally, R^{C} may represent one or more halogen and/or hydrocarbon groups which are bonded to the phenyl ring via oxygen or sulfur, e.g., alkoxy and alkylthio and the like cyclic and optimally aromatic groups.

In embodiments, the nature of the hydrocarbon groups is generally such that the lipophilic character of the polymer is sufficient for it to mix with tile lubricating fluid, and can even dissolve in the lubricating fluid. As such, each of the hydrocarbon substituents may represent: straight chain or branched alkyl which is optionally substituted by one or more halogen, (mono- or poly)cycloalkyl and/or aryl groups, and wherein the cyclic groups, in turn, may be substituted, e. g., by one or more halogen, alkyl, (mono- or poly)cycloalkyl or aryl; (mono- or poly)cycloalkyl, i.e., cycloalkyl which may be mono- or polyclyclic and which is optionally-substituted by one or more halogen, alkyl, (mono- or poly)cycloalkyl arid/or aryl groups, wherein each alkyl group in turn may be substituted, e.g., by one or more halogen, cycloalkyl and/or aryl groups, and each of the cyclic groups, in turn, may be substituted, e. g., by one or more halogen, alkyl, (mono- or poly)cycloalkyl or aryl; aryl which may be mono- or polycyclic such as phenyl, naphthyl and anthracenyl, which is optionally substituted by one or more halogen, alkyl, (mono- or poly)cycloalkyl or aryl groups, wherein each alkyl group in turn may be substituted by one or more halogen, (mono- or poly)cycloalkyl and/or aryl groups, and each of the cyclic groups, in turn, may be substituted, e,g., by one or more halogen, alkyl, (mono- or poly)cycloalkyl and aryl.

In embodiments, the conductivity-inducing and/or antistatic agent can include at least one sulfonic acid R^{a-}SO₃H, or a salt thereof, wherein R^{a} has the above meaning Suitable sulfonic acids can include all sulfonic acids and salts thereof which can convey electrical conductivity to the lubricating fluid or which can reduce the build-up of static charges. Generally, the hydrocarbon group can have at least 6, at least 8, or at least 10 carbon atoms. In embodiments, R^{a} of the sulfonic acid can be an aryl group, or can include at least one aryl group. The aryl group(s) can have from 6 to 14 carbon atoms, such as in phenyl, naphthyl, anthracenyl and the like, and the sulfonic acid moiety can be directly bonded to one of the aryl carbon atoms or be linked to the aryl carbon via a methylene (—CH₂—) bridge. Moreover, the aryl group(s) may carry from one to three halogens and/or hydrocarbon substituents. In embodiments, the aryl sulfonic acid can be a C₆-C₂₀-alkyl-C₆-C₁4-aryl sulfonic acid which can be optionally further substituted by halogen.

Illustrative examples of such aryl sulfonic acids include phenylsulfonic acids in which the phenyl ring optionally carries one, two or three identical or different, straight-chain or branched C₆-C₂₀-alkyl groups. Specific examples include straight-chain or branched hexyl-phenyl sulfonic acid; straight-chain or branched heptyl-phenyl sulfonic acid; straight-chain or branched octyl-phenyl sulfonic acid; straight-chain or branched nonyl-phenyl sulfonic acid; straight-chain or branched decyl-phenyl sulfonic acid; straight-chain or branched undecyl-phenyl sulfonic acid; straight-chain or branched dodecyl-phenyl sulfonic acid; straight-chain or branched tridecyl-phenyl sulfonic acid; straight-chain or branched tetradecyl-phenyl sulfonic acid; straight-chain or branched pentadecyl-phenyl sulfonic acid; straight-chain or branched hexadecyl-phenyl sulfonic acid; straight-chain or branched heptadecyl-phenyl sulfonic acid; straight-chain or branched octadecyl-phenyl sulfonic acid; straight-chain or branched nonadecyl-phenyl sulfonic acid; straight-chain or branched decadecyl-phenyl sulfonic acid; straight-chain or branched mono- or dihexyl-naphthyl sulfonic acid; straight-chain or branched mono- or diheptyl-naphthyl sulfonic acid; straight chain or branched mono- or dioctyl-naphthyl sulfonic acid; straight-chain or branched mono- or dinonyl-naphthyl sulfonic acid; straight-chain or branched mono- or didecyl-naphthyl sulfonic acid; straight-chain or branched mono- or diundecyl-naphthyl sulfonic acid; straight-chain or branched mono- or didodecyl-naphthyl. sulfonic acid; straight-chain or branched mono- or ditridecyl-naphthyl sulfonic acid; straight-chain or branched mono- or ditetradecyl-naphthyl sulfonic acid; straight-chain or branched mono- or dipentadecyl-naphthyl sulfonic acid; straight-chain or branched mono- or dihexadecyl-naphthyl sulfonic acid; straight-chain or branched mono- or diheptadecyl-naphthyl sulfonic acid; straight-chain or branched mono- or dioctadecyl-naphthyl sulfonic acid; straight-chain or branched mono- or dinonadecyl-naplithyl sulfionic acid; and straight-chain or branched mono- or didecadecyl-naphthyl sulfonic acid.

Illustrative examples of conductivity-inducing and/or antistatic agents which are commercially available include STAT-SAFE® 2500 (which comprises a combination of kerosene, o-xylene, dodecylbenzenesulfonic acid, and solvent naphtha), EXPINN® 10 (which comprises a combination of heptane and dodecylbenzenesulfonic acid), STADIS® 450 which includes di-nonyl napthyl sulfonic acid and STADIS® 425. The lubricating fluid may include a single conductivity-inducing and/or antistatic agent or a combination of two or more conductivity-inducing and/or antistatic agents of the same or of different type.

The concentration of the conductivity-inducing and/or anti-static agent(s) in the lubricating fluid can vary broadly. However, in embodiments, the concentration can be kept low such that the overall viscosity of the lubricating fluid is not affected. In embodiments, the concentration of the conductivity-inducing and/or antistatic agent(s) can be from 10 to 5000 ppm in the lubricant, and the treated lubricant has a resistance of less than 50 MQ. For example, 1000 ppm (i.e. 0.1%) of aryl sulfonic acid(s) in a lubricating fluid has been found to give suitable performance.

The lubricating fluid can generally have any desired viscosity. In embodiments, the lubricating fluid can have a viscosity of 15 cp to 80 cp at 0° C. In embodiments, the lubricating fluid can have a viscosity of 25 cp to 70 cp at 0° C. In embodiments, the lubricating fluid can have a viscosity of 25 cp to 60 cp at 0° C.

Disclosed lubricating fluids can offer advantageous properties, especially when utilized in hard disk interface (HDI) applications. For example, disclosed lubricating fluids can have better resistance to oxidation; reduced evaporation effects in high temperature environments; or combinations thereof Both of these properties can decrease contaminant formation in the lubricating fluid which can detrimentally affect HDI applications. Reduced evaporation in high temperature environments can prolong the fluid bearing life of storage applications. Disclosed lubricating fluids can also delay the formation of detrimental gels, when compared with other lubricating fluids. Formation of a gel from the lubricating fluid can lead to significant viscosity changes in the bearing fluid, thus increasing power requirements and consequently lead to bearing failure as well as catastrophic bearing failure due to metal to metal contact. Similarly, disclosed lubricating fluids can also delay the formation of acids, when compared with other lubricating fluids. Formation of acids from the lubricating fluid can be detrimental to HDI applications.

### EXAMPLES

Materials

The materials were obtained from the following suppliers and unless otherwise noted were used as received. IRGANOX® L 57, octylated/butylated diphenylamine; IRGACOR® L 12, succinic acid half ester; and IRGAMET® 39, a tolutriazole derivative were obtained from Ciba Holding, AG (Basel, Switzerland). Bis(2-ethylhexyl)sebacate was obtained from Nye Lubricants (Fairhaven, Mass.). 3-methyl-1,5-pentanediol dinonanoate was synthesized using 1 part 3-methyl-1,5-pentanediol and 2 parts nonaoic acid (Sigma Aldrich, St. Louis, Mo.); the mixture was cleaned up and purified using known procedures. Tetraphenyl resoercinol diphosphate, commercially available as Reofos-RDP® was obtained from Chemtura Corporation (West Lafayette, Ind.). Syn-O-Ad® 8478 a butylated triaryl phosphate additive was obtained from ICL Industrial Products (St. Louis, Mo.). ADDITIN® RC 8500, a carbodiimide; and STABAXOL® 1 LF, a monomeric carbodiimide were obtained from Rhein Chemie Rheinau GmbH (Mannheim, Germany).

Comparative compositions (CC1 through CC3) and experimental compositions C1 through C4) were formulated having the components and amounts (all amounts are given in weight percents) as given in Table 1 below.

TABLE 1

| | Composition | | | | | | |
|---|---|---|---|---|---|---|---|
| Component | CC1 | CC2 | CC3 | C1 | C2 | C3 | C4 |
| IRGANOX ® L 57 | 1.0% | 1.0% | 1.0% | 1.0% | 1.0% | 1.0% | 1.0% |
| IRGACOR ® L 12 | 0.05% | 0.05% | 0.05% | 0.05% | 0.05% | 0.05% | 0.05% |
| IRGAMET ® 39 | 0.05% | 0.05% | 0.05% | 0.05% | 0.05% | 0.05% | 0.05% |
| Reofos-RDP | | 0.25% | 0.5% | | | 0.5% | |
| Syn-O-Ad | | | | 0.5% | 0.5% | | 0.5% |
| ADDITIN ® RC 8500 | | | | | 0.5% | 0.5% | |
| STABAXOL ® 1 LF | | | | | | 0.5% | 0.5% |
| Bis(2-ethylhexyl) sebacate | 98.9% | 98.15% | 98.4% | 98.4% | 97.9% | 97.4% | 97.9% |

### Example 1

Samples of the comparative compositions 1 through 3 and compositions 1 through 4 were kept at 95° C. and 74% relative humidity for 11 days. After 11 days, the hydrolysis of the compositions were measured using GC-MS. The hydrolysis of the base oil was determined by quantifying the monoester of the base oil in the composition. Table 2 reports the percent of hydrolysis (or the percent of the original base oil amount that appeared after 11 days as the monoester).

Samples of the comparative compositions 1 through 3 and compositions 1 through 4 were kept at 95° C. and 74% relative humidity for an additional 14 days (for a total of 25 days) and the physical state of the compositions were noted. The physical state of the compositions are reported in Table 2 below.

TABLE 2

| Composition | % Hydrolysis after 11 days | Physical State after 25 days |
|---|---|---|
| CC1 | 0.25% | Colorless liquid |
| CC2 | 7% | Beige gel |
| CC3 | 27% | Gray gel |
| C1 | 0.3% | Colorless liquid |
| C2 | 0.9% | Colorless liquid |
| C3 | ~0 | Colorless liquid |
| C4 | ~0 | Colorless liquid |

### Example 2

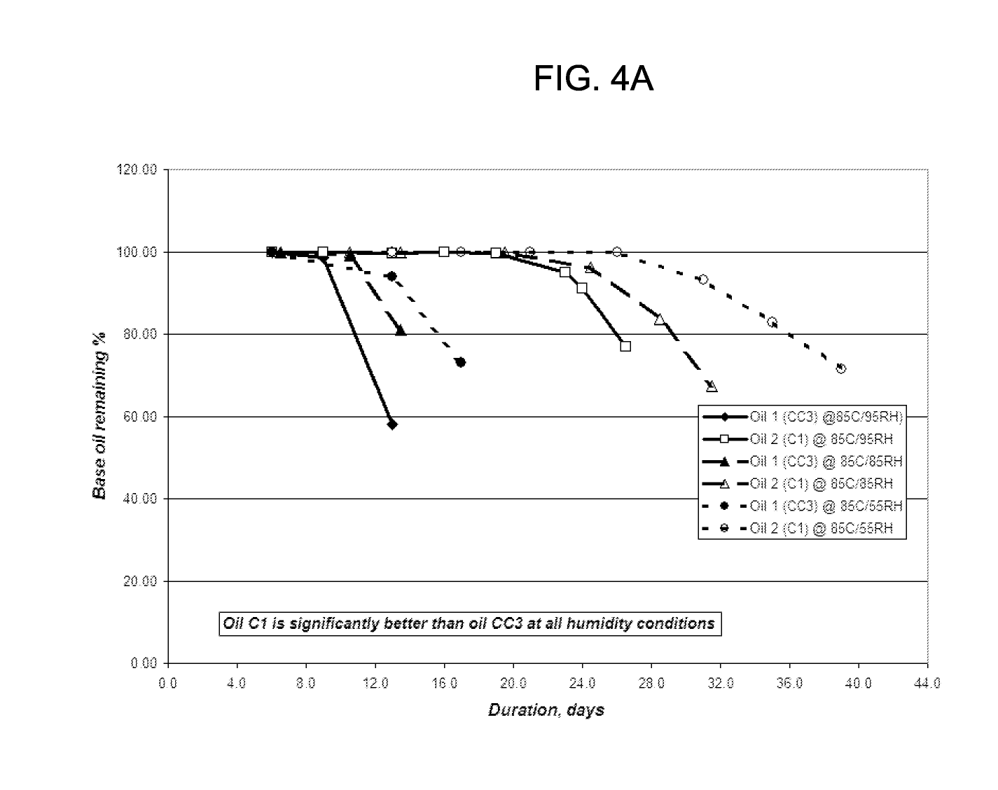

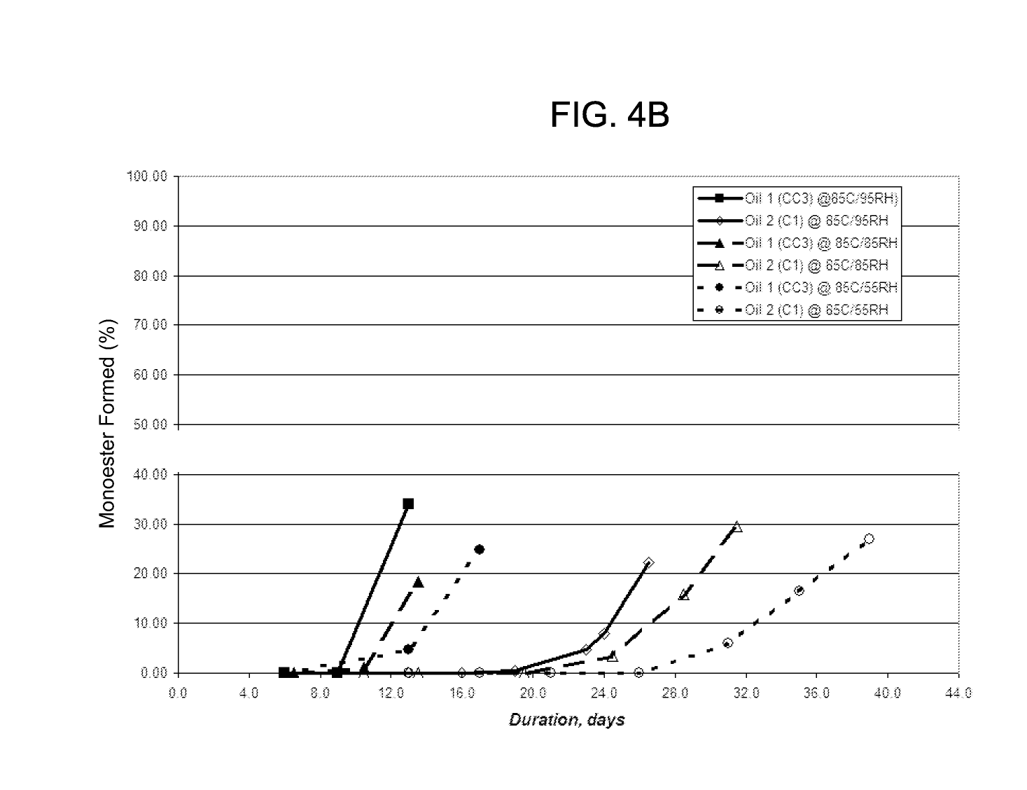

Samples of Comparative Composition 3 (CC3) and Composition 1 (C1) were also maintained at 85° C. and relative humidities of 55%, 85% and 95% for varying amounts of time. Hydrolysis of the samples was monitored (using GC-MS as discussed above) at various time intervals between 4 days and 40 days by monitoring the amount of base oil remaining and the amount of monoester formed. The results are shown in FIGS. 4A (base oil remaining) and 4B (monoester formed).

As seen from FIGS. 4A and 4B, Composition 1 was stable (showed substantially no hydrolysis) for about two times as long as Comparative Composition 3 at various relative humidities.

### Example 2

The hydrolysis of Composition 4, which was the same as Composition 1 but included 0.5% of STABAXOL® 1 LF, a carboiimide compound (and therefore only 97.9% Bis(2-ethylhexyl)sebacate instead of 98.4%) was compared with Composition 1.

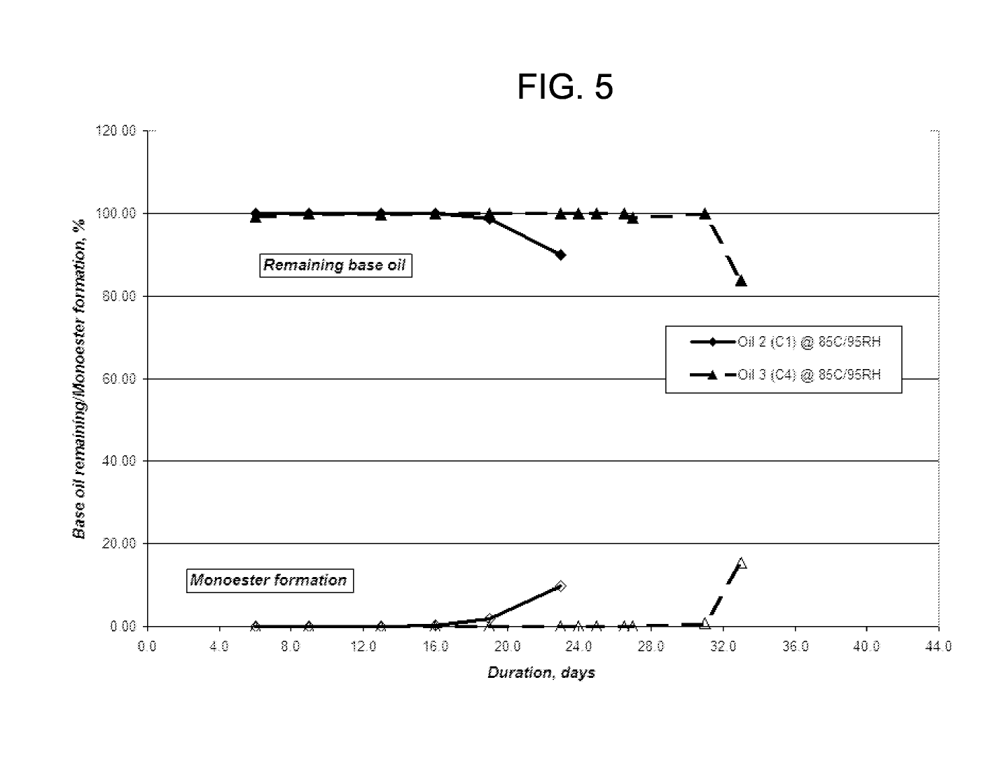

Samples of Composition 1 and Composition 4 were also maintained at 85° C. at a relative humidity of 95% for 33 days. Hydrolysis of the samples was monitored (using GC-MS as discussed above) at various time intervals between 6 days and 33 days. The results are shown in FIG. 5.

As seen from FIG. 5, Composition 4 was stable (showed substantially no hydrolysis) for about 50% longer than Composition 1 (about 19 days versus 31 days).

Thus, embodiments of HYDRODYNAMIC DISC DRIVE SPINDLE MOTOR HAVING HYDRO BEARING WITH LUBRICANTS are disclosed. One skilled in the art will appreciate that the present disclosure can be practiced with embodiments other than those disclosed. The disclosed embodiments are presented for purposes of illustration and not limitation, and the present disclosure is limited only by the claims that follow.

1. A spindle motor comprising:
a stationary member;
a rotatable member which is rotatable with respect to the stationary member; and
a hydro bearing interconnecting the stationary member and the rotatable member and having working surfaces separated by a lubricating fluid, wherein the lubricating fluid comprises:
a) a synthetic ester base fluid having a viscosity index of at least 110;
b) from 0.01% to 5% by weight, based on the total weight of the lubricating fluid, of at least one tri-C₆-C₁₄-aryl phosphate wherein each of the aryl groups has from 1 to 3 identical or different substituents selected from C₁-C₁₂-alkyl groups; and
c) from 0.01% to 5% by weight, based on the total weight of the lubricating fluid, of at least one carbodiimide.

2. The spindle motor according to claim 1, wherein the synthetic ester base fluid comprises
compounds of formula I, 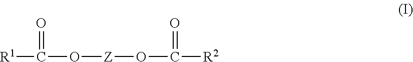
wherein R¹ and R² are identical or different and each represents a straight-chain C₃-C₁₇-alkyl group which optionally carries a C₁-C₃-alkyl bonded to a secondary carbon of the chain; and Z is a straight-chain C₃-C₁₀-alkylene group which optionally carries a C₁-C₃-alkyl bonded to a carbon of the chain;
compounds of formula Ia, 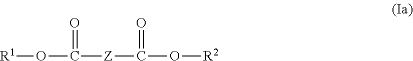
wherein R¹ and R² are identical or different and each represents a straight-chain C₃-C₁₇-alkyl group which optionally carries a C₁-C₃-alkyl bonded to a secondary carbon of the chain; and Z is a straight-chain C₃-C₁₀-alkylene group which optionally carries a C₁-C₃-alkyl bonded to a carbon of the chain;
or combinations thereof.

3. The spindle motor according to claim 1, wherein the carbodiimide is a di-aryl-carbodiimide.

4. The spindle motor according to claim 1, wherein each of the aryl groups on the tri-C₆-C₁₄-aryl phosphate has from 1 to 3 identical or different substituents selected from C₃-C₆-alkyl groups.

5. The spindle motor according to claim 1, wherein the tri-C₆-C₁₄-aryl phosphate is tricresyl phosphate.

6. The spindle motor according to claim 1, wherein the lubricating fluid has a viscosity of from 15 cp to 80 cp at 0° C.

7. The spindle motor according to claim 1, wherein the lubricating fluid further comprises an additive selected from the group consisting of antioxidants, corrosion inhibitors, viscosity index modifiers, pour point depressants, anti-foaming agents and electrically conductive, non-metallic additives.

8. The spindle motor according to claim 7, wherein the lubricating fluid comprises from 0.01% to 5% by weight, based on the total weight of the lubricating fluid, of at least one antioxidant.

9. The spindle motor according to claim 7, wherein the lubricating fluid comprises from 0.01% to 5% by weight, based on the total weight of the lubricating fluid, of at least one corrosion inhibitor.

10. The spindle motor according to claim 7, wherein the lubricating fluid comprises from 0.01% to 5% by weight, based on the total weight of the lubricating fluid, of at least one viscosity index modifier.

11. The spindle motor according to claim 7, wherein the lubricating fluid comprises from 0.01% to 5% by weight, based on the total weight of the lubricating fluid, of at least one pour point depressant.

12. The spindle motor according to claim 7, wherein the lubricating fluid comprises from 0.01% to 5% by weight, based on the total weight of the lubricating fluid, of at least one anti-foaming agent.

13. The spindle motor according to claim 1, wherein the lubricating fluid further comprises a polyalphaolefin base fluid.

14. The spindle motor according to claim 1, wherein the synthetic ester base fluid comprises 3-methyl-1,5-pentanediol di(n-hexanoate), 3-methyl-1,5-pentane-diol di(n-heptanoate), 3-methyl-1,5-pentanediol di(n-octanoate), 3-methyl-1,5-pentanediol di(n-nonanoate), and 3-methyl-1,5-pentanediol di(n-deaconate), 3-methyl-1,5-pentanediol di(n-undecanoate), 3-methyl-1,5-pentanediol di(n-dodecanoic), and 3-methyl-1,5-pentanediol di(n-tridecanoate), or combinations thereof.

15. A spindle motor comprising:
a stationary member;
a rotatable member which is rotatable with respect to the stationary member; and
a hydro bearing interconnecting the stationary member and the rotatable member and having working surfaces separated by a lubricating fluid, wherein the lubricating fluid comprises:
a) a synthetic ester base fluid having a viscosity index of at least 110;
b) from 0.01% to 5% by weight, based on the total weight of the lubricating fluid, of at least one butylated triphenyl phosphate; and
c) from 0.01% to 5% by weight, based on the total weight of the lubricating fluid, of at least one carbodiimide.

16. The spindle motor according to claim 15, wherein the at least one butylated triphenyl phosphate is present in a total amount of from 0.1% to 4% by weight of the lubricating fluid.

17. The spindle motor according to claim 15, wherein the carbodiimide is present in a total amount of from 0.1% to 3% by weight of the lubricating fluid.

18. The spindle motor according to claim 15, wherein the carbodiimide is selected from compounds of formula (II)
X—N═C═N—Y (II)
wherein
X and Y are identical or different and each represents a C₁-C₂₀-hydrocarbon residue which may be, or comprise, aliphatic, cycloaliphatic and aromatic groups.

19. The spindle motor according to claim 15 further comprising a liquid amine phosphate antiwear additive.

20. A lubricating fluid comprising:
a) a synthetic ester base fluid having a viscosity index of at least 110;
b) from 0.01% to 5% by weight, based on the total weight of the lubricating fluid, of at least one tri-C₆-C₁₄-aryl phosphate wherein each of the aryl groups has from 1 to 3 identical or different substituents selected from C₁-C₁₂-alkyl groups; and
c) from 0.01% to 5% by weight, based on the total weight of the lubricating fluid, of at least one carbodiimide.
